(19) United States
(12) Patent Application Publication
(10) Pub. No.: US 2002/0134205 A1
(43) Pub. Date: Sep. 26, 2002

(54) Quick release coupling device for tool members

(76) Inventor: Shao Hsien Hsu, Taichung (TW)

Correspondence Address: Shao Hsien HSU, P.O. Box 63-99, Taichung, 406, TW

(21) Appl. No.: 09/816,573

(22) Filed: Mar. 22, 2001

(51) Int. Cl. B25G 1/00; B25B 23/16

(52) U.S. Cl. 81/177.85

(57) ABSTRACT

A tool device includes a driving shank having a bore and a channel formed in one end and communicating with each other. A tool member is detachably received in the bore of the driving shank and has one or more notches formed in the outer peripheral portion. A latch is slidably engaged in the channel of the driving shank and has straight bar for engaging into the notch of the tool member and for detachably and solidly securing the tool member to the driving shank. A barrel is slidably engaged on the driving shank for forcing the latch to solidly engage with the tool member.

### BACKGROUND OF THE INVENTION

1. Field of the Invention

The present invention relates to a tool, and more particularly to a tool including a quick release coupling device for detachably securing a fastener or a tool bit or the like to the tool.

2. Description of the Prior Art

Typical tools, particularly the tool extensions of the tools, as shown in FIGS. 1-4, comprise a driving shank body 10 including an extension 101 having a reduced outer diameter formed or extended from one end thereof, and having an orifice 13 formed therein for receiving a spherical ball 13. A barrel 11 is rotatably engaged onto the extension 101 of the driving shank body 10 and includes a peripheral recess 18 (FIG. 2) formed therein for receiving the spherical ball 13. A spring 12 is engaged into the barrel 11 and engaged between the barrel 11 and the driving shank body 10 for biasing the barrel 11 relative to the driving shank body 10 and for disengaging the peripheral recess 18 of the barrel 11 from the spherical ball 13, and for forcing the spherical ball 13 inward of the bore 103 of the driving shank body 10. A ring 15 may be secured to the barrel 11 with a clamping ring or a retaining ring 14 in order to retain the spring 12 in the barrel 11. A fastener or a tool bit or the other tool member or the like may be engaged into the bore 103 of the driving shank body 10 and includes a number of notches 17 formed in the outer peripheral portion thereof. The spherical ball 13 may be forced to engage into the notches 17 of the tool bit 16 (FIG. 2) in order to detachably secure the tool member 16 in the driving shank body 10.

However, the spherical ball 13 is contacted with the driving shank body 10 with several points only and may not be solidly engaged in the notches 17 of the tool member 16, such that the notches 17 of the tool member 16 may be easily damaged by the ball 13.

The present invention has arisen to mitigate and/or obviate the afore-described disadvantages of the conventional tools.

### SUMMARY OF THE INVENTION

The primary objective of the present invention is to provide a tool including a quick release coupling device for detachably securing a fastener or a tool bit or the like to the tool.

In accordance with one aspect of the invention, there is provided a tool device comprising a driving shank body including a first end having a bore formed therein and having a channel formed therein and communicating with the bore of the driving shank body, a tool member detachably received in the bore of the driving shank body and including a peripheral portion having at least one notch formed therein, a latch slidably engaged in the channel of the driving shank body and including an inner portion having a straight bar formed and provided therein for engaging into the notch of the tool member and for detachably securing the tool member to the driving shank body, a barrel slidably engaged on the first end of the driving shank body and including a peripheral recess formed therein for receiving the latch and for allowing the latch to be disengaged from the tool member, and means for biasing the barrel relative to the driving shank body to disengage the peripheral recess of the barrel from the latch and to force the latch to engage with the tool member. The bar has an increased area engaged with the tool member for allowing the tool member to be solidly secured to the driving shank body by the latch.

The straight bar includes at least one inclined surface formed therein for facilitating an engagement of the straight bar into the at least one notch of the tool member

The barrel includes a curved inner peripheral portion, the latch includes an outer portion having a curved outer surface formed therein for engaging with the curved inner peripheral portion of the barrel.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view showing a typical tool device;

FIG. 2 is a cross sectional view taken along lines 2-2 of FIG. 3;

FIG. 3 is a cross sectional view taken along lines 3-3 of FIG. 2;

FIG. 4 is an enlarged partial cross sectional view showing the engagement of a ball in the notch of the tool member of the typical tool device;

FIG. 5 is an exploded view showing a tool device in accordance with the present invention;

FIG. 6 is a perspective view of a latch of the tool device;

FIG. 7 is a cross sectional view taken along lines 7-7 of FIG. 9;

FIG. 8 is a cross sectional view similar to FIG. 7, illustrating the operation of the tool device;

FIG. 9 is a cross sectional view taken along lines 9-9 of FIG. 7; and

FIG. 10 is an enlarged partial cross sectional view showing the engagement of a ball in the notch of the tool member of the present tool device.

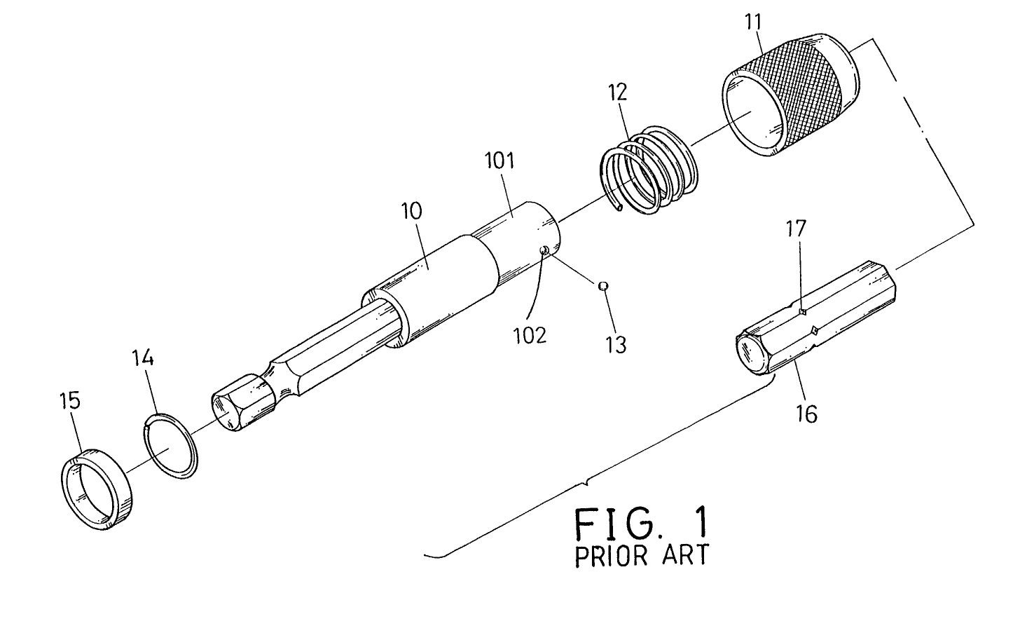

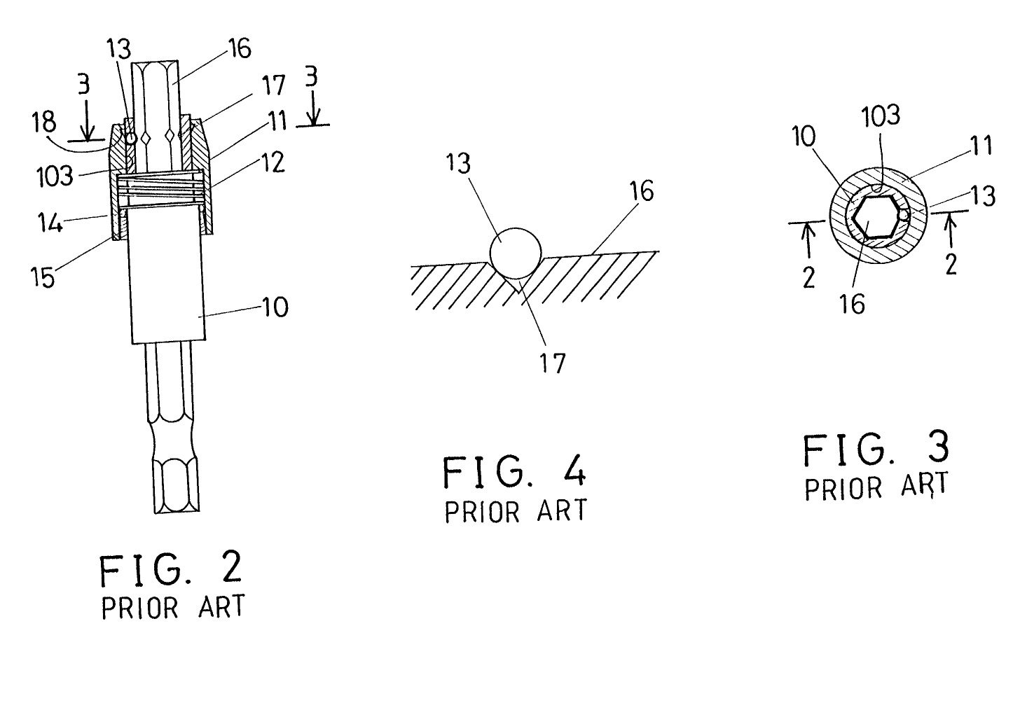

### DETAILED DESCRIPTION OF THE PREFERRED EMBODIMENT

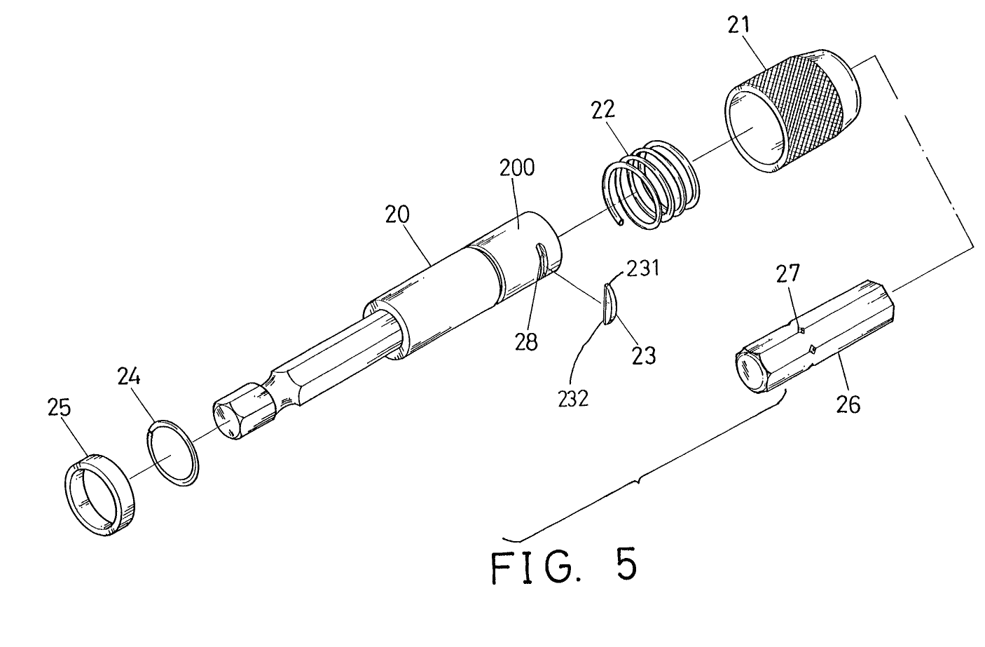

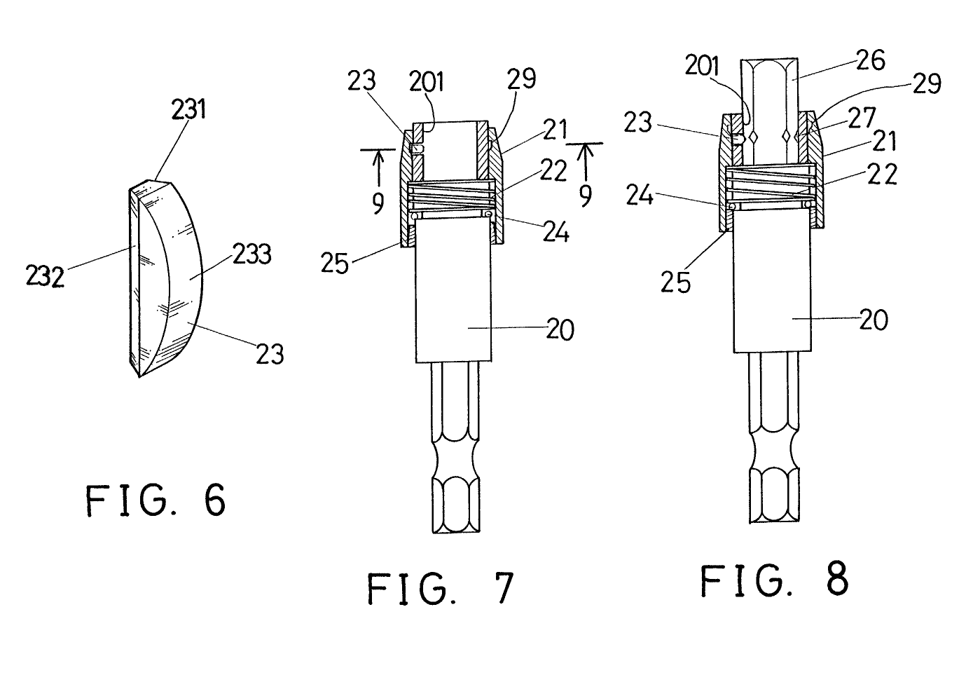

Referring to the drawings, and initially to FIGS. 5-9, a tool device in accordance with the present invention comprises a driving shank body 20 including a front end 200 having a bore 201 formed therein for detachably receiving a tool member 26, such as a tool bit 26 therein. A barrel 21 is rotatably engaged onto the front end 200 of the driving shank body 20 and includes a peripheral recess 29 (FIGS. 7, 8) formed therein. A spring 22 is engaged into the barrel 21 and engaged between the barrel 21 and the driving shank body 20 for biasing the barrel 21 relative to the driving shank body 20. A ring 25 may be secured to the barrel 21 with a clamping ring or a retaining ring 24 in order to retain the spring 22 in the barrel 21. A fastener or a tool bit or the other tool member 26 or the like may be engaged into the bore 200 of the driving shank body 20 and includes a number of notches 27 formed in the outer peripheral portion thereof.

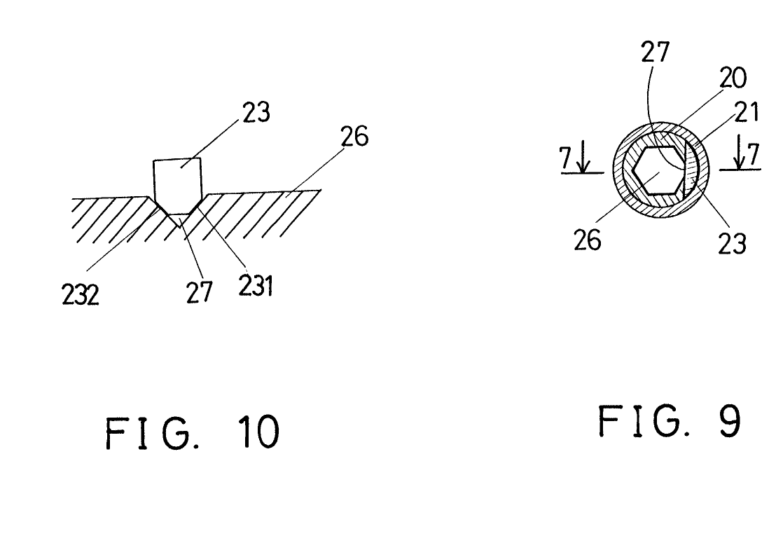

The driving shank body 20 includes a channel 28 formed therein and communicating with the bore 201 thereof. A latch 23 is slidably received in the channel 28 of the driving shank body 20 and includes a straight bar 231 formed on one side thereof and includes a curved outer surface 233 formed on the other side opposite to the straight bar 231, and includes one or more tapered or inclined surfaces 232 formed on the outer peripheral portion of the straight bar 231 for facilitating the engagement of the bar 231 into the notches 27 of the tool member 26 (FIGS. 9, 10), and for allowing the latch 23 to detachably secure the tool member 26 in the driving shank body 20.

As best shown in FIG. 9, the curved outer surface 233 of the latch 23 has a curvature corresponding to the inner peripheral portion of the driving shank body 20, for allowing the latch 23 to be effectively and solidly forced to engage with the tool member 26.

In operation, as shown in FIG. 7, when the barrel 21 is moved relative to the driving shank body 20 against the spring 22 in order to align the latch 23 with the peripheral recess 29 of the barrel 21, the latch 23 may be received in the peripheral recess 29 of the barrel 21 for allowing the tool member 26 to be engaged into the bore 201 of the driving shank body 20. As shown in FIG. 8, when the barrel 21 is released, the spring 22 may bias and move the barrel 21 relative to the driving shank body 20 and may disengage the peripheral recess 29 of the barrel 21 from the latch 23 such that the latch 23 may be forced to engage inward of the bore 201 of the driving shank body 20 and to engage into either of the notches 27 of the tool member 26, for allowing the latch 23 to detachably secure the tool member 26 in the driving shank body 20.

It is to be noted that the latch 23 has a bar 231 solidly engaged with the tool member 26 with a surface contact, such that the tool member 26 may be solidly secured to the driving shank body 20 with the latch 23 and the tool member 26 will not be damaged by the latch 23.

Accordingly, the tool device in accordance with the present invention includes a quick release coupling device for detachably securing a fastener or a tool bit or the other tool member to the tool and includes a latch for solidly securing the tool member to the driving shank.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tool device comprising:
a driving shank body including a first end having a bore formed therein and having a channel formed therein and communicating with said bore of said driving shank body,
a tool member detachably received in said bore of said driving shank body and including a peripheral portion having at least one notch formed therein,
a latch slidably engaged in said channel of said driving shank body and including an inner portion having a straight bar formed and provided therein for engaging into said at least one notch of said tool member and for detachably securing said tool member to said driving shank body,
a barrel slidably engaged on said first end of said driving shank body and including a peripheral recess formed therein for receiving said latch and for allowing said latch to be disengaged from said tool member, and
means for biasing said barrel relative to said driving shank body to disengage said peripheral recess of said barrel from said latch and to force said latch to engage with said tool member.

2. The tool device according to claim 1, wherein said straight bar includes at least one inclined surface formed therein for facilitating an engagement of said straight bar into said at least one notch of said tool member

3. The tool device according to claim 1, wherein said barrel includes a curved inner peripheral portion, said latch includes an outer portion having a curved outer surface formed therein for engaging with said curved inner peripheral portion of said barrel.
